(19) United States
(12) Patent Application Publication
(10) Pub. No.: US 2026/0228268 A1
(43) Pub. Date: Aug. 6, 2026

(54) SYSTEMS AND METHODS FOR INTEGRATION OF GENERATIVE ARTIFICIAL INTELLIGENCE FOR REPORTS AND ACTIONS

(71) Applicant: Schlumberger Technology Corporation, Sugar Land, TX (US)

(72) Inventors: Laurent Butre, Paris (FR); Josselin Kherroubi, Clamart (FR); Dan Lockyer, Clamart (FR); Florian Le Blay, Clamart (FR); Jean-Marc Pietrzyk, Montpellier (FR); Myriam Amour, Montpellier (FR); Agustin Soriano Rementeria, Montpellier (FR); Valerian Guillot, Montpellier (FR); Laurent Vallet, Montpellier (FR)

(21) Appl. No.: 19/042,171

(22) Filed: Jan. 31, 2025

(51) Int. Cl. G06F 16/34; G06F 16/3332; G06F 16/387; G06F 40/186

(52) U.S. Cl. CPC G06F 16/345; G06F 16/3334; G06F 16/387; G06F 40/186

(57) ABSTRACT

A tangible, non-transitory, computer-readable medium comprising instructions that, when executed by processing circuitry, are configured to cause the processing circuitry to retrieve one or more sets of data, transmit the one or more sets of data to an artificial intelligence (AI) model, transmit at least one instruction to the AI model to elicit summarization of one or more sets of data into a summarized one or more subsets of data, selectively extract portions of the one or more subsets of data based on a pre-determined criteria, and generate a report of one or more extracted subsets of data and/or action by the AI model based on at least one instruction of one or more sets of data.

### BACKGROUND

The present disclosure generally relates to systems and methods for integrating generative artificial intelligence (AI) for reports and actions.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Generally, entities are becoming increasingly interested in traceability of communications at a job site. Currently, most communications on a job site are conducted via phones or portable radios and may be undocumented. Manual notes based on these communications may omit key information and may be subject to errors or bias. A written transcript of these communications may be beneficial on a job site to mitigate any communication discrepancies of key details that were forgotten or misconstrued.

Entities are also concerned about addressing health, safety, and environment (HSE) leading indicator solutions. Leading indicator solutions are proactive measures used to identify and mitigate potential workplace HSE incidents before they occur. Currently, HSE leading indicator solutions are only based on HSE reports, which require individuals to stop doing what they are doing and file a report based on an observed unsafe activity. While this process has proved to be manageable in the industry, it has some shortcomings, such as the invasiveness of the act of reporting and personal bias.

Communication updates regarding the activities of the day including HSE incidents are provided in daily reports. However, daily reports can be time-consuming and prone to missing key information, creating misalignment or inefficiencies in job performance.

To create comprehensive and accurate daily reports, a compilation of key information from all interactions that occurred between different communication channels is required. Daily reports can be accelerated if different communication channels can be linked, and key actions can be extracted. However, incorporating other sources of communication data may be challenging to retrieve, extract, and/or summarize due to the large volume and/or complexity of the data. Therefore, the entities are interested in accelerating report generation by quickly extracting and highlighting critical information across all communication channels.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with an embodiment, a tangible, non-transitory, computer-readable medium comprising instructions that, when executed by processing circuitry, are configured to cause the processing circuitry to retrieve one or more sets of data, transmit the one or more sets of data to an artificial intelligence (AI) model, transmit at least one instruction to the AI model to elicit summarization of one or more sets of data into a summarized one or more subsets of data, selectively extract portions of the one or more subsets of data based on a predetermined criteria, and generate a report of one or more extracted subsets of data and/or action by the AI model based on at least one instruction of one or more sets of data.

In accordance with an embodiment, a method, comprising of retrieving one or more sets of data, transmitting the one or more sets of data to an artificial intelligence (AI) model, transmitting at least one instruction to the AI model to elicit summarization the one or more sets of data into a summarized one or more subsets of data, selectively extracting portions of the one or more subsets of data based on a predetermined criteria and generating a report of one or more extracted subsets of data and/or action by the AI model based on at least one instruction of one or more sets of data.

In accordance with an embodiment, a system, comprising of a processing circuitry configured to retrieve one or more sets of data, transmit the one or more sets of data to an artificial intelligence (AI) model, transmit at least one instruction to the AI model to elicit summarization the one or more sets of data into a summarized one or more subsets of data; selectively extract portions of the one or more subsets of data based on a predetermined criteria, and generate a report of one or more extracted subsets of data and/or action by the AI model based on at least one instruction of one or more sets of data.

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a flow diagram of a communication data system, in accordance with an embodiment of the present disclosure;

FIG. 2 is a flow chart of a method for generating a report based on audio data, in accordance with an embodiment of the present disclosure; and

FIG. 3 is a flow chart of a method for summarizing and generating a report based on data from different data sources, in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled) and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

The present embodiments described herein include a communication data system, which generates a particular report, task, or an action by retrieving, extracting, summarizing, and/or processing a set of data. The communication data system retrieves (e.g., receives, fetches, etc.) the set of data from one or more of a variety of data sources (e.g., written sources, pager system or radios, voice recording devices, etc.) associated with the one or more entities. This retrieval can be repeated for additional entities. The data format may be associated with one or more data source. For example, the communication data system may receive one or more portable document formats (PDFs) associated with a written source or convert a data source into a PDF for each respective data source. Further, the communication data system may continuously monitor the one or more data sources for updates to the set of data, ensuring the set of data remains relevant. The communication data system may then extract relevant information or tasks from the set of data. As an example, the communication data system may employ a vision model to process text and/or one or more images and integrate visual features with text processing capabilities to extract relevant text and/or image descriptions. Additionally, and/or alternatively, optical character recognition (OCR) can be utilized to identify relevant text and/or images and extract the relevant text and/or images.

Moreover, the communication data system may then summarize the one or more subsets of data based on a template (e.g., daily report, HSE report, or the like). In some embodiments, the template may be based on one or more standards (e.g., one or more industry standards). In other embodiments, the user may customize the template via one or more user inputs. In this manner, implementation of the template may enable a user-guided bias toward specific data types.

The communication data system may process the one or more subsets of data via an artificial intelligence (AI) engine and based on one or more user inputs and/or an additional template. Further, the communication data system may receive a request to generate a report. In some embodiments, the communication data system may receive the one or more user inputs selecting one or more report parameters (e.g., HSE incident, date/time, work progress, or the like). Alternatively, the communication data system may generate a report based on a template (e.g., a set of sequenced questions, instructions, or the like). Thus, the communication data system may generate the report based on the one or more subsets of data, the template, and/or the one or more user inputs. The communication data system may then present the report. In this manner, the communication data system may improve data management, summarization, and/or visualization by efficiently gathering, summarizing, and/or presenting the data.

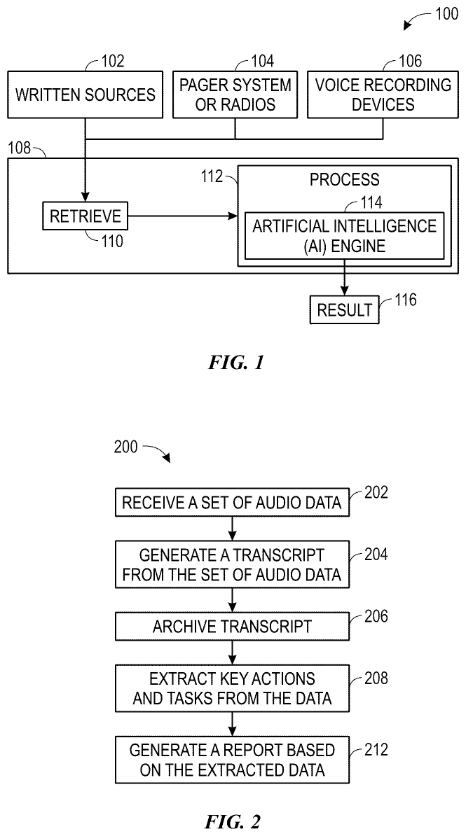

With the foregoing in mind, FIG. 1 is a flow diagram of processes performed in a communication data system 100, in accordance with an embodiment of the present disclosure. In some embodiments, the communication data system 100 may include a processing device (e.g., processing circuitry, processing system) with at least a processor capable of executing computer-executable code to perform the operations described below. The processing device of the communication data system 100 may operate in conjunction with a deep-learning processor or a neural-network processor and/or, for example, the processing device may include a large language model (LLM), machine learning, and/or artificial intelligence (AI)-based processors.

For example, in one or more embodiments, a deep-learning processor or a neural-network processor, and/or, for example a large language model (LLM), machine learning (ML), and/or AI based processor of the communication data system can execute instructions stored in memory and/or storage of the communication data system as one or more analysis modules to execute one or more of the operations described herein. Likewise, the operations described herein may be instituted via a processing device (e.g., processing circuitry, processing system) with at least a processor capable of executing computer-executable code to perform the operations described herein via a local computing device and the AI functions described herein can be performed on a server or in the cloud as coupled to the local computing device of the communication data system. In some embodiments, a processing device of the communication data system 100 may operate in conjunction with a deep-learning processor or a neural-network processor and/or, for example, the processing device may include large language model (LLM), machine learning, and/or artificial intelligence (AI)-based processors.

Therefore, the AI may be integrated into the communication data system 100 (or remotely coupled thereto) and can operate as a component that utilizes models interconnected with other components of the communication data system 100. In some embodiments, the AI may function separately (e.g., independently) from the communication data system 100. Further, the AI may be coupled to the communication data system 100 via a cloud (e.g., a cloud-based integration) enabling utilization of the models hosted remotely on the cloud. The communication data system 100 may also include memory and/or storage, which may be any suitable articles of manufacture that serve as media to store processor-executable code, data, or the like. These articles of manufacture may represent computer-readable media (e.g., any suitable form of memory or storage) that may store processor-executable code used by the processor to perform the below noted techniques. It should be noted that the communication data system 100 may perform at least some of the processes described herein in parallel (e.g., simultaneously) or at separate times (e.g., in series).

The communication data system 100 may operate to process a set of communication data from one or more data sources associated with one or more entities. The set of communication data may be associated with one or more metrics of each respective entity of the one or more entities. For example, the one or more entities may include companies in the oil and gas industry, companies in the construction industry, companies in the cement industry, companies in manufacturing industry, or any other companies. The one or more data sources may include one or more written sources 102, one or more pager system or radios 104, and/or one or more voice recording devices 106.

The one or more written sources 102 may be associated with written sources that stop unsafe work activity (e.g., STOP cards), email communications that are happening at the job site, or daily reports. For example, STOP cards are handwritten cards that state the unsafe work activity observed and actions needed to mitigate the hazard. These, and similar, cards, reports, etc. can constitute the written sources 102 in a native format (e.g., as handwritten items) or a converted format (e.g., scanned items). As an example, the communication data system 100 may receive or convert written data or audio data to one or more portable document formats (PDFs) associated with the communication data for each respective data source (e.g., each respective entity).

The one or more pager system or radios 104 may be associated with numeric pagers, alphanumeric pagers, two-way pagers, mobile radios, portable handheld radios, specialized radios, etc. Numeric pagers receive codes up to 10 digits that can correlate to a phone number or a pre-defined message while alphanumeric pagers can show text messages and phone numbers. Two-way pagers can receive and send text messages to the sender. Mobile radios, for example, are located inside vehicles for employees to communicate with each other while driving or otherwise moving. Portable handheld radios are two-way radios that can send and receive voice messages. These and similar specialized radios may be associated with security or specific communication systems with different frequency bands, signal types, power levels, and/or encryption and data transmission abilities. The one or more pager system or radios 104 provide efficient methods of communication, as they can be used to quickly communicate between distances, for example, in one or more entities.

In some embodiments, the one or more voice recording devices 106 may be associated with conversations between employees using phones, computers, smartphones, tablets, voice recorders, cameras, and/or any other similar devices at the job site. One or more voice recording devices 106 can operate to record audio data.

The one or more written sources 102, one or more pager system or radios 104, and/or one or more voice recording devices 106 each have communication data to be processed in the data processing circuitry 108. The data processing circuitry 108 consists of retrieving data (block 110) and transmitting the data to the artificial intelligence (AI) engine 114.

In block 110, the data processing circuitry 108 may retrieve a set of communication data from one or more written sources 102, one or more pager system or radios 104, and/or one or more voice recording devices 106. The retrieval of data from the one or more written sources 102, one or more pager system or radios 104, and/or one or more voice recording devices 106 can be in response to a request from the communication data system 100 and refresh operations (i.e., scheduled retrievals of data from the one or more written sources 102, one or more pager system or radios 104, and/or one or more voice recording devices 106) can be performed at the same frequency or at differing frequencies relative to one another.

The data processing circuitry 108 may request and/or receive data from any number of entities and that data can include data from, for example, the one or more written sources 102, the one or more pager system or radios 104, and/or the one or more voice recording devices 106. It should be noted that while the communication data system 100 is described as retrieving the set of data via one or more written sources 102, one or more pager system or radios 104, and/or one or more voice recording devices 106, the data processing circuitry 108 may retrieve data via any suitable data source. In addition, it should be noted that the communication data system 100 may retrieve data from internal sources (e.g., an entity associated with the user).

In block 112, the data processing circuitry 108 may extract relevant information during operations or information closely related to operations and job activities via the artificial intelligence (AI) engine 114, from the set of communication data. Examples of types of relevant information can include one or more HSE incidents, key actions that occurred during the operations, and/or other metrics. This data (i.e., the relevant information) can be selected from predetermined types of data based on what information is to be represented in the final compiled report, for example daily morning report, daily shift reports, HSE report, or the like. The extraction of the relevant data can be accomplished via a command transmitted to the program or an AI model trained to detect objects, for example, in images (e.g., a computer vision model). Additionally, and/or alternatively, the extraction of the relevant data can be accomplished via an executed code that instructs the computer vision model to extract the relevant information, for example, using a template (e.g., daily morning report, daily shift reports, HSE report, or the like) generated for particular relevant information extraction. As another example, the template may be customized based on the one or more user inputs that specify a type of data to be summarized.

In this manner, the relevant information may include at least a portion of the set of communication data. That is, the data processing circuitry 108 may extract relevant text and/or images from the set of data. To assist in accomplishing the extraction, the communication data system 100 may employ as noted above, for example, a computer vision model, which may process images using deep learning techniques (e.g., a neural network or AI on a local device of the communication data system or connected thereto and hosted in a remote server, in the cloud, etc.) to extract one or more features from each report and provide, for example an ASCII (e.g., textual version) of the retrieved communication data from block 102. As another example, the communication data system 100 may employ a computer-based vision technique, such as optical character recognition (OCR) to extract images and/or text from each report associated with each respective entity. Additionally, or alternatively, the communication data system 100 may apply OCR to extract a textual version of each report associated with each respective entity. After extraction of the relevant information from the set of communication data, the communication data system 100 may assemble (e.g., compile, combine) the extracted set of communication data into a textual format.

The data processing circuitry 108 may extract information from the set of data and process the data in tiers. Data can be organized in levels of priority with Tier 1 being the highest priority and Tier 3 being the lowest priority. Tier 1 may be one or more written sources 102 (e.g., STOP cards, email communications that are happening at the rig site or daily reports). Tier 2 may be one or more pager system or radios 104 (e.g. rig pager system or radios). Tier 3 may be one or more voice recording devices 106 (e.g. human conversations at the rig site, by either voice recording devices on specific locations or portable ones carried by individuals).

In block 112, the data processing circuitry 108 may process the one or more subsets of report data via an AI engine 114 (e.g., AI system), which may employ an AI model (e.g., the same AI model described above or a separate AI model with both or either local to the computing device of the communication data system 100 or remotely connected thereto and present in a server, the cloud, or the like). In one embodiment, the data processing circuitry 108 may input the one or more subsets of data into the AI engine 114 to adjust (e.g., refine, fine-tune) the AI model based on the one or more subsets of data and/or enable query of the one or more subsets of data. Accordingly, the data processing circuitry 108 may provide an output via the AI engine 114 in a format that aligns with requested (e.g., desired) output parameters for a model optimization scheme. Indeed, the output parameters may be requested by the user via one or more inputs to the data processing circuitry 108.

The artificial intelligence (AI) engine 114 may summarize the extracted set of report data. For example, artificial intelligence (AI) engine 114 may separate each data included in the set of communication data while maintaining consistency (e.g., organization) of each portion of the report. As another example, extraction and/or summarization of the communication could be provided using artificial intelligence (AI) engine 114 daily or for each shift. This summarization or portions of summarization can augment and accelerate the daily reports.

To summarize the extracted set of data, the data processing circuitry 108 may employ an AI model (e.g., a generative model, LLM) to perform summarization tasks. For example, the data processing circuitry 108 may employ the AI model to perform searching on the extracted set of data and summarize the extracted set of data. The data processing circuitry 108 may perform summarization based on a template. It should be noted that the template may include processor-executable code that may be executed by the processor device of the data processing circuitry 108 to direct the AI model to extract and summarize the one or more subsets of report data for each report. As such, the data processing circuitry 108 may employ the template to generate the summarized one or more subsets of report data. As an example, the template may be customized based on the one or more user inputs that specify a type of data to be summarized. In some embodiments, the user may run one or more queries via a customized template.

In another example, the artificial intelligence (AI) engine 114 will conduct an interpretation for immediate actions, for problems described or mentioned that will be recorded from shift to shift and become part of the report. The artificial intelligence (AI) engine 114 will identify the tone of the conversation to evaluate factors such as morale, positiveness in the conversation, and level of stress. The artificial intelligence (AI) engine will identify locations where most of the incidents are occurring or the location where the potential HSE issues are concentrated in. The artificial intelligence (AI) engine will also identify unreported issues, and intangibles, such as morale and stress to highlight when a potential HSE issue might occur ahead of it happening.

In some embodiments, the data processing circuitry 108 may store the processed data in the memory (e.g., within a database) of the data processing circuitry 108 or any other suitable memory to enable efficient retrieval and analysis of data at subsequent times. Further, in some embodiments, the data processing circuitry 108 may incrementally develop and/or store the data after processing to facilitate efficient retrieval and analysis of the data at the subsequent times. In other embodiments, the AI engine 114 may store the processed data.

In addition, a retrieval component of the AI engine 114 may be customized (e.g., via the one or more user inputs) to query the one or more data sources. Indeed, the retrieval component of the AI engine 114 may be customized to search, identify, and/or separate (e.g., partition) data based on an associated entity and/or industry based on one or more user queries. The AI engine114 can also translate any languages into a predetermined language, for example, English.

The AI engine 114 may also incorporate user or system feedback to improve the extractions of key information or recognize key terms. For example, the AI engine 114 may recognize previously used terms and acronyms and avoid processing repetitive data received. The AI engine 114 can also implement previously approved recommendations for similar incidents or tasks.

The data processing circuitry 108 may receive a request to generate a result 116. The result 116 can be a report or an action. For example, the user may input the request to generate a report (e.g., Daily report, HSE report) based on a desire to identify and/or obtain comprehensive data (e.g., or any other suitable data) from the one or more data sources.

The data processing circuitry 108 may also trigger an action as a result 116. For example, a user could trigger a memo and/or a task. In addition, tasks can be triggered via a keyword, or tasks can be extracted from a text analysis. For example, tasks may include sending a reminder, recording a reminder, and/or sharing the reminder within the one or more entities. The data processing circuitry 108 can also trigger an action to equipment (i.e., a particular machine or system). For example, the data processing circuitry 108 can transmit a control signal to equipment, and the equipment can execute an action based on the action received. In another example, the artificial intelligence (AI) engine will provide a result 116 such as a recommendation for an action, where appropriate and focus on what type of actions, when, and where the actions are to be undertaken.

The user may also desire to analyze trends of the one or more subsets of report data (e.g. HSE data trends). As such, the data processing circuitry 108 may input the one or more subsets of data into the AI engine 114 to cause analysis of the one or more subsets of report data by making comparisons, identifying patterns, etc. Visual indicators as part of a graphical user interface (GUI) may be part of the result 116 for the actions that are described. For example, the result 116 can be transmitted for display on a display for selection and/or notification to a user. Trends can also be analyzed and presented via a visualization tool to generate result 116. Visualization tool may be a generative AI system that is the same AI as AI engine 114 or a different AI engine and can generate as the result 116 (or part of the result 116) a data visualization and/or a report platform. In operation, the visualization tool may present a user interface that enables the user to create their own report. For example, the user may input the request to the visualization tool to generate the visualized report based on a desire to identify and/or visualize comprehensive data (e.g., or any other suitable data) from the one or more data sources.

Additionally, or alternatively, a template may define one or more parameters and/or visualization of the report. For example, the template for a daily report may include one or more parameters, metrics, and/or desired data to be included in the report such as date and time, personnel details, summary of activities conducted, equipment status, HSE incidents and observations, issues, hazards, communication needed for the next shift, performance metrics, priorities, any anticipated actions, and any approvals and signatures.

The template may also be transmitted to the visualization tool in place or (or in addition to) user inputs to generate the report. Thus, the communication data system 100 may generate the report based on the one or more subsets of report data output via the AI engine 114 (if it includes the visualization tool) or via a standalone visualization tool using users'inputs and/or template associated with a particular desired reporting. The template may include processor-executable code that may be executed by the processor device of the data processing circuitry 108. Moreover, the template may specify a set of queries (e.g., targeted queries) in a sequence. In operation, the template may be transmitted (e.g., sent) to the AI engine 114 (and/or the visualization tool) of the communication data system 100 to cause deployment of the report.

The data processing circuitry 108 may then present (e.g., display) the report as result 116 (or part of result 116) via a display (e.g., an electronic display), or any other suitable display a part of or in communication (e.g., wired or wirelessly) with the data processing circuitry 108, for visualization by the user. Multiple templates may be present whereby each of the templates are linked (e.g., tied, connected) to generation of a particular report that may be generated by the data processing circuitry 108. For example, separate templates may be generated for entities in separate industries.

In another example, the data processing circuitry 108 may, after extracting and summarizing the data, rank the HSE incidents by risk or isolate the source of the problem. For example, the data processing circuitry 108 may generate an output by categorizing and risk ranking the HSE information and hazards. The data processing circuitry 108 may analyze the severity, likelihood, and the consequences of each hazard and generate a report comprising of a risk ranking based on the input received.

In another example, based on the inputs from the one or more written sources 102, one or more pager system or radios 104, and/or one or more voice recording devices 106, the data processing circuitry 108 may generate a well HSE risk rating for drilling and drilling related operations. The well may comprise of a wellbore, casing, and surface equipment. The data processing circuitry 108 will extract and summarize the risks indicated from the one or more written sources 102, one or more pager system or radios 104, and/or one or more voice recording devices 106. The risk factors that will be evaluated will be the severity and the likelihood of an adverse event occurring. The data processing circuitry 108 may generate a risk matrix and/or a risk rating based on these factors. The higher risk rating number would indicate a higher likelihood of an adverse event occurring.

In another example, based on the inputs from the one or more written sources 102, one or more pager system or radios 104, and/or one or more voice recording devices 106, the data processing circuitry 108 may generate a rig HSE rating for rig related maintenance and non-drilling related operations. The data processing circuitry 108 will extract and summarize the risks indicated from the one or more written sources 102, one or more pager system or radios 104, and/or one or more voice recording devices 106. The risk factors that will be evaluated will be the severity and the likelihood of an adverse event occurring. The data processing circuitry 108 may generate a risk matrix and/or a risk rating based on these factors. The higher risk rating number would indicate a higher likelihood of an adverse event occurring.

In addition, based on the inputs from the one or more written sources 102, one or more pager system or radios 104, and/or one or more voice recording devices 106, the data processing circuitry 108 may generate a recommendation that will be outputted to operating personnel. The data processing circuitry 108 will extract and summarize the recommendation indicated from the one or more written sources 102, one or more pager system or radios 104, and/or one or more voice recording devices 106. The data processing circuitry 108 will then generate a recommendation to operating personnel within the one or more entities.

As described herein, the data processing circuitry 108 may generate a transcript and/or storage of the transcript via the memory of the communication data system or a memory of the AI engine 114. With this in mind, FIG. 2 is a flow chart of a method for generating a report based on extracted audio data, in accordance with an embodiment of the present disclosure. It should be noted that one or more blocks of the method 200 need not necessarily be performed by the processing circuitry of the data processing circuitry 108 and/or by the AI model (respectively) in the illustrated order. For example, one or more of the blocks of method 200 can be performed in parallel. Moreover, various blocks of the method 200 of FIG. 2 can be performed, for example, by the data processing circuitry 108, which can operate in conjunction with a deep-learning processor or a neural-network processor and/or, for example, the processing circuitry may include large language model (LLM), machine learning, and/or AI-based processors.

At block 202, the data processing circuitry 108 may receive a set of audio data. For example, the data processing circuitry 108 may receive the set of audio data via the one or more data sources, such as the one or more pager system or radios 104, and/or one or more voice recording devices 106. The data processing circuitry 108 can selectively and/or continuously record audio data during operations at a job site. For example, the communication data system 100 may have microphones and may operate to encrypt recorded data so as not to allow unauthorized access to the recorded or otherwise captured audio data.

The audio data may be in one or more formats comprising and not limited to uncompressed audio formats, (e.g., WAV, AIFF, AU or raw header-less PCM), formats with lossless compression, (e.g., FLAC, Monkey's Audio (filename extension .ape), WavPack (filename extension .wv), TTA, ATRAC Advanced Lossless, ALAC (filename extension .m4a), MPEG-4 SLS, MPEG-4 ALS, MPEG-4 DST, Windows Media Audio Lossless (WMA Lossless), and Shorten (SHN)), and formats with lossy compression, (e.g., Opus, MP3, Vorbis, Musepack, AAC, ATRAC and Windows Media Audio Lossy (WMA lossy)).

At block 204, the data processing circuitry 108 may generate a transcript from the set of audio data. The generated transcript will be an accurate and detailed representation of the communication data between users. In some embodiments, the transcript will be punctuated accordingly and identify the different speakers using voice recognition of the user. The AI engine will utilize advanced speech-to-text (STT) technology and will allow a transcript to be processed using audio data. The transcript will also be user-friendly and will allow the users to see the transcript during the communication as it is being generated. The users can highlight key actions in the transcript as they are communicating. If there is poor audio quality, the transcript will notify the users and allow the users to correct any errors stated in the transcript.

At block 206, the data processing circuitry 108 may archive the transcript. In some embodiments, the data processing circuitry 108 may store the processed data in the memory (e.g., within a database) of the data processing circuitry 108 or any other suitable memory to enable efficient retrieval and analysis of data at subsequent times. The transcript will also be archived by category and will tag all the users in the transcript. The transcript will be archived in a predetermined and/or selectable format (e.g., PDF, .docx, or the like). Further, in some embodiments, the data processing circuitry 108 may incrementally develop and/or store the data after processing to facilitate efficient retrieval and analysis of the data at the subsequent times. In other embodiments, the AI engine 114 may store the processed data.

In another non-limiting example, a user will be allowed to search keywords within the transcripts. In addition, a retrieval component of the AI engine 114 may be customized (e.g., via the one or more user inputs) to query the one or more data sources. Indeed, the retrieval component of the AI engine 114 may be customized to search, identify, and/or separate (e.g., partition) data based on an associated entity and/or industry based on one or more user queries.

At block 208, the data processing circuitry 108 may extract key actions and tasks from the data. The communication data system may extract relevant information, such as particular metrics, from the set of data. Examples of types of relevant information can include one or more of, for example, incidents, HSE leading indicators, key words, actions, tone, and/or other metrics. This data (i.e., the relevant information) can be selected from predetermined types of data based on what information is to be represented in the final compiled report, for example. The extraction of the relevant data can be accomplished via a command transmitted to the program or an AI model trained to detect key information. Special keywords may be used to ask the data processing circuitry 108 to specifically capture an element to highlight in the daily report. Additionally, and/or alternatively, the extraction of the relevant data can be accomplished via an executed code that instructs the computer vision model to extract the relevant information, for example, using a template (e.g., a set of sequenced questions, instructions, or the like) generated for the particular relevant information extraction.

In this manner, the relevant information may include at least a portion of the set of data. That is, the data processing circuitry 108 may extract relevant text from each set of data. As another example, the data processing circuitry 108 may employ a computer-based vision technique, such as optical character recognition (OCR) to extract text from each transcript.

At block 210, the data processing circuitry 108 may generate a report based on the extracted data. After extraction of the relevant information from the set of data, the data processing circuitry 108 may assemble (e.g., compile, combine) the extracted set of data into a textual format. The data processing circuitry 108 may perform summarization based on a template. As such, the data processing circuitry 108 may employ the template to generate the summarized one or more subsets of data.

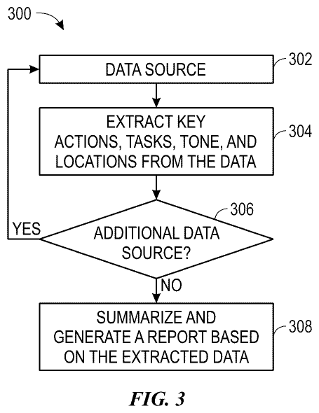

As described herein, the data processing circuitry 108 may employ the summarized one or more subsets of data to generate a report. FIG. 3 is a flowchart of a method 300 for summarizing and generating a result 116, in accordance with an embodiment of the present disclosure. It should be noted that one or more blocks of the method 300 may be performed by the data processing circuitry 108 in any suitable order. For example, the data processing circuitry 108 can operate in conjunction with a deep-learning processor or a neural-network processor and/or, for example, the processing circuitry may include large language model (LLM), machine learning and/or AI based processors.

At block 302, the data processing circuitry 108 may receive a set of data source. The communication data system receives the set of data from one or more of a variety of data sources (e.g., written sources 102, pager system or radios 104, or voice recording devices 106) associated with the one or more entities.

At block 304, key actions, tasks, tone, and locations from the data are extracted. The communication data system may extract key actions, tasks, tone, and locations from the set of data. This data (i.e., key actions, tasks, tone, and locations) can be selected from predetermined types of data based on what information is to be represented in the final compiled report, for example.

For example, actions detected during the communications could be extracted and highlighted for the manager to add or not into the next daily report. The extraction of the key data can be accomplished via a command transmitted to the program or an AI model trained to detect key information. Additionally, and/or alternatively, the extraction of the key data can be accomplished via an executed code that instructs the computer vision model to extract the relevant information, for example, through the use of a template (e.g., a set of sequenced questions, instructions, or the like) generated for the particular relevant information extraction.

At block 306, additional data sources are incorporated. This retrieval of data can be repeated for additional data sources. The data processing circuitry 108 retrieves (e.g., receives, fetches) the set of data from one or more of a variety of data sources (e.g., written sources 102, pager system or radios 104, or voice recording devices 106) associated with the one or more entities. This retrieval can be repeated without limitations.

At block 308, the data processing circuitry 108 may then summarize the one or more subsets of data and generate a report based on a template (e.g., daily report, HSE report, or the like). In some embodiments, the template may be based on one or more standards (e.g., one or more industry standards).

The technical effect of the disclosed embodiments includes an improvement in data management, summarization, and/or generation of a report or an action. Indeed, the data processing circuitry 108 efficiently generates one or more reports and actions associated with the one or more entities by retrieving, extracting, summarizing, and/or processing the set of data to provide a comprehensive interpretation of the data to the user. Further, the data processing circuitry 108 may automatically collect the communication data from the one or more data sources and build a comprehensive database including the data for efficient retrieval and analysis at a subsequent time. The data processing circuitry 108 may create dynamic and real-time reports, while also providing the one or more entities with actionable insights.

The subject matter described in detail above may be defined by one or more clauses, as set forth below.

In certain embodiments, a tangible, non-transitory, computer-readable medium comprising instructions that, when executed by processing circuitry, are configured to cause the processing circuitry to retrieve one or more sets of data; transmit the one or more sets of data to an artificial intelligence (AI) model; transmit at least one instruction to the AI model to elicit summarization of one or more sets of data into a summarized one or more subsets of data; selectively extract portions of the one or more subsets of data based on a pre-determined criteria; and generate a report of one or more extracted subsets of data and/or action by the AI model based on at least one instruction of one or more sets of data.

The tangible, non-transitory, computer-readable medium of the preceding clause, wherein the instructions, when executed by the processing circuitry, further cause the processing circuitry to receive a user input and generate the report via the AI model based in part on the user input.

The tangible, non-transitory, computer-readable medium of the preceding clause, wherein the instructions, when executed by the processing circuitry, further cause the processing circuitry to generate the report via the AI model based on a template in conjunction with the user input.

The tangible, non-transitory, computer-readable medium of any of the preceding clauses, wherein the instructions, when executed by the processing circuitry, further cause the processing circuitry to transmit a control signal to equipment, wherein the equipment executes an action based on the control signal received.

The tangible, non-transitory, computer-readable medium of the preceding clause, wherein the instructions, when executed by the processing circuitry, further cause the processing circuitry to select the template from a set of templates each corresponding to a respective report.

The tangible, non-transitory, computer-readable medium of the preceding clause, wherein the instructions, when executed by the processing circuitry, further cause the processing circuitry to perform a task, wherein the task can be triggered via a keyword or extracted from a text, wherein the task comprises sending a reminder, recording the reminder, and/or sharing the reminder within one or more entities.

The tangible, non-transitory, computer-readable medium of any of the preceding clause, wherein the instructions, when executed by the processing circuitry, further cause the processing circuitry to update the report in response to a second set of data received by the AI model.

The tangible, non-transitory, computer-readable medium of the preceding clause, wherein the instructions, when executed by the processing circuitry, further cause the processing circuitry to identify one or more subsets of data as indicative of an action occurring or a speech indicator of a speaker, wherein the speech indicator includes tone, diction, vocabulary, pitch, or volume.

The tangible, non-transitory, computer-readable medium of the preceding clause, wherein the instructions, when executed by the processing circuitry, further cause the processing circuitry to identify a location corresponding to an occurrence of an incident.

In certain embodiments, a method comprising retrieving one or more sets of data; transmitting the one or more sets of data to an artificial intelligence (AI) model; transmitting at least one instruction to the AI model to elicit summarization of the one or more sets of data into a summarized one or more subsets of data; selectively extracting portions of the one or more subsets of data based on a pre-determined criteria; and generating a report of one or more extracted subsets of data and/or action by the AI model based on at least one instruction of one or more sets of data.

The method of the preceding clause, further comprising receiving a user input and generating the report via the AI model based in part on the user input.

The method of the preceding clause, further comprising generating the report via the AI model based on a template in conjunction with the user input.

The method of any of the preceding clauses, further comprising generating the report via the AI model based in part on a template.

The method of the preceding clause, further comprising selecting the template from a set of templates each corresponding to a respective report.

The method of any of the preceding clauses, further comprising identifying locations corresponding to an occurrence of an incident.

The method of any of the preceding clauses, further comprising updating the report in response to a second set of data received by the AI model.

The method of the preceding clause, further comprising providing a recommendation for action, wherein the recommendation comprises what, when, and where the actions are required.

In certain embodiments, a system comprising processing circuitry configured to retrieve one or more sets of data; transmit the one or more sets of data to an artificial intelligence (AI) model; transmit at least one instruction to the AI model to elicit summarization of the one or more subsets of data into a summarized one or more subsets of data; selectively extract portions of the one or more subsets of data based on a pre-determined criteria; and generate a report of one or more extracted subsets of data and/or action by the AI model based on at least one instruction of one or more sets of data.

The system of the preceding clause, wherein the processing circuitry is further configured to generate the report via the AI model based on a received user input or a template.

The system of any of the preceding clauses, wherein the processing circuitry is further configured to provide a recommendation for actions, wherein the recommendation comprises what, when, and where the actions are required.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

1. A tangible, non-transitory, computer-readable medium comprising instructions that, when executed by processing circuitry, are configured to cause the processing circuitry to:
retrieve one or more sets of data;
transmit the one or more sets of data to an artificial intelligence (AI) model;
transmit at least one instruction to the AI model to elicit summarization of one or more sets of data into a summarized one or more subsets of data;
selectively extract portions of the one or more subsets of data based on a pre-determined criteria; and
generate a report of one or more extracted subsets of data and/or action by the AI model based on at least one instruction of one or more sets of data.

2. The tangible, non-transitory, computer-readable medium of claim 1, wherein the instructions, when executed by the processing circuitry, further cause the processing circuitry to receive a user input and generate the report via the AI model based in part on the user input.

3. The tangible, non-transitory, computer-readable medium of claim 2, wherein the instructions, when executed by the processing circuitry, further cause the processing circuitry to generate the report via the AI model based on a template in conjunction with the user input.

4. The tangible, non-transitory, computer-readable medium of claim 1, wherein the instructions, when executed by the processing circuitry, further cause the processing circuitry to transmit a control signal to equipment, wherein the equipment executes an action based on the control signal received.

5. The tangible, non-transitory, computer-readable medium of claim 3, wherein the instructions, when executed by the processing circuitry, further cause the processing circuitry to select the template from a set of templates each corresponding to a respective report.

6. The tangible, non-transitory, computer-readable medium of claim 4, wherein the instructions, when executed by the processing circuitry, further cause the processing circuitry to perform a task, wherein the task can be triggered via a keyword or extracted from a text, wherein the task comprises sending a reminder, recording the reminder, and/or sharing the reminder within one or more entities.

7. The tangible, non-transitory, computer-readable medium of claim 1, wherein the instructions, when executed by the processing circuitry, further cause the processing circuitry to update the report in response to a second set of data received by the AI model.

8. The tangible, non-transitory, computer-readable medium of claim 7, wherein the instructions, when executed by the processing circuitry, further cause the processing circuitry to identify one or more subsets of data as indicative of an action occurring or a speech indicator of a speaker, wherein the speech indicator includes tone, diction, vocabulary, pitch, or volume.

9. The tangible, non-transitory, computer-readable medium of claim 8, wherein the instructions, when executed by the processing circuitry, further cause the processing circuitry to identify a location corresponding to an occurrence of an incident.

10. A method, comprising:
retrieving one or more sets of data;
transmitting the one or more sets of data to an artificial intelligence (AI) model;
transmitting at least one instruction to the AI model to elicit summarization of the one or more sets of data into a summarized one or more subsets of data;
selectively extracting portions of the one or more subsets of data based on a pre-determined criteria; and
generating a report of one or more extracted subsets of data and/or action by the AI model based on at least one instruction of one or more sets of data.

11. The method of claim 10, further comprising receiving a user input and generating the report via the AI model based in part on the user input.

12. The method of claim 11, further comprising generating the report via the AI model based on a template in conjunction with the user input.

13. The method of claim 10, further comprising generating the report via the AI model based in part on a template.

14. The method of claim 13, further comprising selecting the template from a set of templates each corresponding to a respective report.

15. The method of claim 10, further comprising identifying locations corresponding to an occurrence of an incident.

16. The method of claim 10, further comprising updating the report in response to a second set of data received by the AI model.

17. The method of claim 16, further comprising providing a recommendation for action, wherein the recommendation comprises what, when, and where the actions are required.

18. A system, comprising:
processing circuitry configured to:
retrieve one or more sets of data;
transmit the one or more sets of data to an artificial intelligence (AI) model;
transmit at least one instruction to the AI model to elicit summarization of the one or more sets of data into a summarized one or more subsets of data;
selectively extract portions of the one or more subsets of data based on a pre-determined criteria; and
generate a report of one or more extracted subsets of data and/or action by the AI model based on at least one instruction of one or more sets of data.

19. The system of claim 18, wherein the processing circuitry is further configured to generate the report via the AI model based on a received user input or a template.

20. The system of claim 18, wherein the processing circuitry is further configured to provide a recommendation for actions, wherein the recommendation comprises what, when, and where the actions are required.
